(19) United States
(12) Patent Application Publication
(10) Pub. No.: US 2017/0068489 A1
(43) Pub. Date: Mar. 9, 2017

(54) IMAGE FORMING APPARATUS, IMAGE FORMING METHOD

(71) Applicant: KYOCERA Document Solutions Inc., Osaka (JP)

(72) Inventors: Paolo Alonso, Osaka (JP); Jaclyn Tiffanie Tan, Osaka (JP); Ronie Aquino, Osaka (JP); Helen Escosar, Osaka (JP)

(21) Appl. No.: 15/173,268

(22) Filed: Jun. 3, 2016

(30) Foreign Application Priority Data
Sep. 8, 2015 (JP) 2015-176363

(51) Int. Cl. G06F 3/12; G06K 15/00; H04N 1/00

(52) U.S. Cl. CPC G06F 3/121; H04N 1/00411; H04N 1/00413; H04N 1/00474; H04N 1/00477; G06F 3/1296; G06F 3/1292; G06F 3/1234; G06K 15/4085; H04N 2201/0094

(57) ABSTRACT

An image forming apparatus includes a print processing portion, a selection processing portion, and an output processing portion. The print processing portion executes a print process based on print data. The selection processing portion, when the print process has been interrupted, selects, as an output destination of the print data processed in the interrupted print process, either an image forming apparatus with which its associated image forming apparatus can communicate, or an external storage apparatus to which its associated image forming apparatus is connected, in accordance with a user operation. The output processing portion executes an external output process for outputting at least one of the print data and unprocessed data to the output destination selected by the selection processing portion after the print process has been interrupted, the unprocessed data being part of the print data on which the print process has not been executed.

### INCORPORATION BY REFERENCE

This application is based upon and claims the benefit of priority from the corresponding Japanese Patent Application No. 2015-176363 filed on Sep. 8, 2015, the entire contents of which are incorporated herein by reference.

### BACKGROUND

The present disclosure relates to an image forming apparatus and an image forming method for executing a print process based on print data.

In an image forming system in which print data is transmitted from an information processing apparatus such as a personal computer to an image forming apparatus such as a printer and a print process is executed, the print process may be interrupted by a failure, such as a paper jam, that occurs in the image forming apparatus. There is known an image forming system in which, when such an interruption occurs, print data processed in the print process is transmitted to another image forming apparatus that can communicate with the image forming apparatus, and the print process is restarted. In addition, there is known an image forming system in which unprocessed print data is transmitted from the image forming apparatus to a mobile terminal so that a print process for the unprocessed print data can be executed in another image forming apparatus.

### SUMMARY

An image forming apparatus according to an aspect of the present disclosure includes a print processing portion, a selection processing portion, and an output processing portion. The print processing portion executes a print process based on print data. The selection processing portion, when the print process has been interrupted, selects, as an output destination of the print data processed in the interrupted print process, either an image forming apparatus with which its associated image forming apparatus can communicate, or an external storage apparatus to which its associated image forming apparatus is connected, in accordance with a user operation. The output processing portion executes an external output process for outputting at least one of the print data and unprocessed data to the output destination selected by the selection processing portion after the print process has been interrupted, the unprocessed data being part of the print data on which the print process has not been executed.

An image forming method according to another aspect of the present disclosure is an image forming method executed by a processor installed in an image forming apparatus, and includes a print step, a selection step, and an output step. In the print step, a print process is executed based on print data. In the selection step, when the print process has been interrupted, either an image forming apparatus with which its associated image forming apparatus can communicate or an external storage apparatus to which its associated image forming apparatus is connected, is selected in accordance with a user operation as an output destination of the print data processed in the interrupted print process. In the output step, an external output process is executed to output at least one of the print data and unprocessed data to the output destination selected in the selection step after the print process has been interrupted, wherein the unprocessed data is part of the print data on which the print process has not been executed.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic configuration diagram showing an image forming system according to an embodiment of the present disclosure.

FIG. 2 is a flowchart showing an example of a print control process executed by an image forming apparatus according to an embodiment of the present disclosure.

FIG. 3 is a diagram showing an example of a display screen displayed on the image forming apparatus according to an embodiment of the present disclosure.

FIG. 4 is a diagram showing an example of a display screen displayed on the image forming apparatus according to an embodiment of the present disclosure.

FIG. 5 is a diagram showing an example of a display screen displayed on the image forming apparatus according to an embodiment of the present disclosure.

### DETAILED DESCRIPTION

The following describes an embodiment of the present disclosure with reference to the accompanying drawings for the understanding of the disclosure. It should be noted that the following embodiment is an example of a specific embodiment of the present disclosure and should not limit the technical scope of the disclosure.

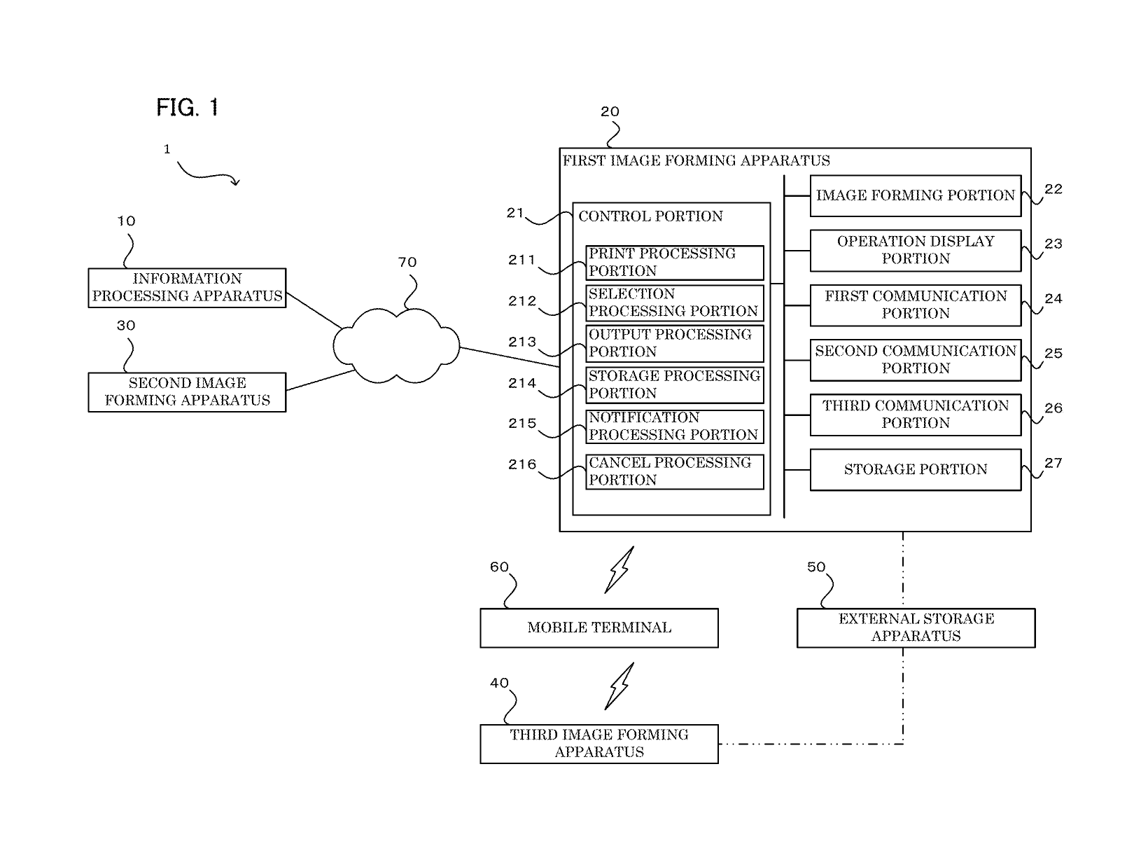

As shown in FIG. 1, an image forming system 1 according to an embodiment of the present disclosure includes at least one information processing apparatus 10, at least one first image forming apparatus 20, at least one second image forming apparatus 30, at least one third image forming apparatus 40, at least one external storage apparatus 50, and at least one mobile terminal 60.

The information processing apparatus 10, the first image forming apparatus 20, and the second image forming apparatus 30 are communicably connected to a communication network 70 which is, for example, the Internet or a LAN, and can perform a mutual data communication among them. It is noted that in the present embodiment, the third image forming apparatus 40 and the mobile terminal 60 are not communicably connected to the communication network 70. On the other hand, the first image forming apparatus 20 and the mobile terminal 60 can perform a mutual communication between them in accordance with a wireless communication standard such as Bluetooth (registered trademark) or NFC (Near Field Communication).

The information processing apparatus 10 is, for example, a personal computer, a smartphone, a mobile phone, a tablet terminal, or a PDA. In addition, the mobile terminal 60 is, for example, a smartphone, a mobile phone, a tablet terminal, or a PDA. The information processing apparatus 10 and the mobile terminal 60 can transmit print data to the first image forming apparatus 20 or the second image forming apparatus 30 via the communication network 70, and cause the image forming apparatus 20 or 30 to execute a print process. For example, the information processing apparatus 10 and the mobile terminal 60 each cause a printer driver installed therein to convert information generated by any of various applications to PDL (Page Description Language) data and output the PDL data as the print data.

The external storage apparatus 50 is a USB memory that can be attached to and detached from an apparatus such as the first image forming apparatus 20 or the third image forming apparatus 40, and is a nonvolatile storage portion to/from which various data can be written and read. It is noted that, not limited to the USB memory, the external storage apparatus 50 may be a memory card, a hard disk drive (HD), a solid-state drive (SSD) or the like. Furthermore, the mobile terminal 60 that has a storage device inside is also an example of the external storage apparatus 50.

The first image forming apparatus 20, the second image forming apparatus 30, and the third image forming apparatus 40 are each a printer that can execute a print process based on image data transmitted from the information processing apparatus 10, the mobile terminal 60 or the like. It is noted that the first image forming apparatus 20, the second image forming apparatus 30, and the third image forming apparatus 40 each may be a multifunction peripheral that has a print function and other functions such as a scan function, a copy function, and a facsimile function.

Here, an outlined configuration of the first image forming apparatus 20 is described. It is noted that description of the sheet conveying portion 30 and the third image forming apparatus 40 is omitted since they have a similar configuration to the first image forming apparatus 20.

As shown in FIG. 1, the first image forming apparatus 20 includes a control portion 21, an image forming portion 22, an operation display portion 23, a first communication portion 24, a second communication portion 25, a third communication portion 26, and a storage portion 27.

The control portion 21 includes control equipment such as CPU, ROM, and RAM that are not shown. The CPU is a processor that executes various calculation processes. The ROM is a nonvolatile storage portion in which various information such as control programs for causing the CPU to execute various processes are stored in advance. The RAM is a volatile storage portion, and is used as a temporary storage memory (working area) for the various processes executed by the CPU. The control portion 21 comprehensively controls the first image forming apparatus 20 by executing the various control programs stored in advance in the ROM or the storage portion 27, by using the CPU.

The image forming portion 22, controlled by the control portion 21, forms an image on a sheet such as a sheet of paper by using developer such as toner. For example, when the image forming portion 22 is an electrophotographic image forming portion, the image forming portion 22 is provided with a photoconductor drum, a charging device, an exposure device, a developing device, a transfer device, and a fixing device. It is noted that the image forming portion 22 may be an image forming portion adapted to another method such as an inkjet method.

The operation display portion 23 includes a display portion and an operation portion. The display portion is, for example, a liquid crystal display for displaying various types of information based on control instructions from the control portion 21. The operation portion is composed of, for example, hard keys and a touch panel through which various types of information are input to the control portion 21 in accordance with user operations.

The first communication portion 24 is a communication interface that can perform wired or wireless data communication with apparatuses such as the information processing apparatus 10 and the second image forming apparatus 30 via the communication network 70.

The second communication portion 25 is a communication interface that can store or read data in/from the external storage apparatus 50 attached to the first image forming apparatus 20. Specifically, in the present embodiment, since the external storage apparatus 50 is a USB memory, the second communication portion 25 includes a USB process portion that performs writing and reading data to/from the USB memory via a USB connector in accordance with a USB standard.

The third communication portion 26 is a communication interface that can perform a wireless data communication with an external communication apparatus such as the mobile terminal 60 in accordance with a communication protocol such as Bluetooth (registered trademark).

The storage portion 27 is a storage portion such as a hard disk drive (HD) or a solid state drive (SSD). In the storage portion 27, a print program for causing the CPU of the control portion 21 to execute a print control process that is described below (see the flowchart of FIG. 4), is stored in advance. It is noted that the print program may be recorded on a computer-readable recording medium such as a CD, a DVD, or a flash memory, and may be installed from the recording medium to the storage portion 27. In addition, print data that is received from an external apparatus such as the information processing apparatus 10, is also stored in the storage portion 27.

Meanwhile, in the image forming system 1, a print process being executed in the first image forming apparatus 20 may be interrupted by a failure such as a paper jam. In that case, as a method for printing the print data whose printing has been interrupted, (a) a second image forming apparatus 30 that can be communicated with the first image forming apparatus 20 or (b) a third image forming apparatus 40 that can not be communicated with the first image forming apparatus 20 is selected, depending on the user or the circumstances. In such a case, in the first image forming apparatus 20, it is possible to arbitrarily select a method for printing the print data whose printing has been interrupted.

Specifically, as shown in FIG. 1, the control portion 21 includes a print processing portion 211, a selection processing portion 212, an output processing portion 213, a storage processing portion 214, a notification processing portion 215, and a cancel processing portion 216. It is noted that the control portion 21 functions as these processing portions when it executes the print program stored in the storage portion 27 by using the CPU. It is also noted that one or more processing portions among those of the control portion 21 may be provided as an electronic circuit such as an integrated circuit (ASIC).

The print processing portion 211 executes a print process for forming an image on a sheet based on the print data stored in the storage portion 27, by controlling the image forming portion 22 based on the print data. For example, when the print data is the PDL data, the print processing portion 211 converts the PDL data to image data such as bit map data. The print processing portion 211 outputs the image data to the image forming portion 22 sequentially so that the image forming portion 22 can execute the print process.

The selection processing portion 212, when a print process has been interrupted, executes a process of selecting, in accordance with a user operation, an output destination of the print data processed in the interrupted print process. Specifically, the selection processing portion 212 selects, in accordance with a user operation, either a second image forming apparatus 30 with which its associated first image forming apparatus 20 can communicate, or an external storage apparatus 50 to which its associated first image forming apparatus 20 is connected. For example, the selection processing portion 212 can set the output destination in advance when the print process is interrupted or started or when the first image forming apparatus 20 is initialized. In addition, the control portion 21 can also set whether to cause the selection processing portion 212 to make the selection, in accordance with a user operation performed when, for example, the first image forming apparatus 20 is initialized.

The output processing portion 213 executes an external output process for outputting at least one of the print data and unprocessed data to the output destination selected by the selection processing portion 212 after the print process has been interrupted, wherein the unprocessed data is part of the print data on which the print process has not been executed. For example, when the second image forming apparatus 30 is selected as the output destination, the output processing portion 213 transmits the print data to the second image forming apparatus 30 via the first communication portion 24 and the communication network 70. In particular, when the output destination is the second image forming apparatus 30, the output processing portion 213 may output only the unprocessed data, among the print data, on which the print process has not been executed. In addition, when the external storage apparatus 50 is selected as the output destination, the output processing portion 213 causes the second communication portion 25 to store the print data and the unprocessed data in the external storage apparatus 50. In particular, when it stores the print data in the external storage apparatus 50, the output processing portion 213 may output the print data and the unprocessed data as separate files.

The storage processing portion 214, upon execution of the external output process by the output processing portion 213, stores the print data in the storage portion 27 provided in the first image forming apparatus 20. After the storage of the print data, the storage processing portion 214 deletes the print data from the storage portion 27 after a predetermined storage period passes since the storage of the print data.

The notification processing portion 215, upon execution of the external output process by the output processing portion 213, notifies the output destination. Specifically, the notification processing portion 215 notifies the user of the information processing apparatus 10 of the output destination, by transmitting information of the output destination of the print data or the unprocessed data to the information processing apparatus 10 that is the transmission source of the print data.

The cancel processing portion 216, upon execution of the external output process by the output processing portion 213, cancels the print process of printing the print data in the first image forming apparatus 20. That is, in the first image forming apparatus 20, even if the failure that has interrupted the print process is recovered, the print process for the print data is not restarted. On the other hand, when the external output process is not executed by the output processing portion 213, the print process for the print data is restarted in the first image forming apparatus 20 after the failure is recovered.

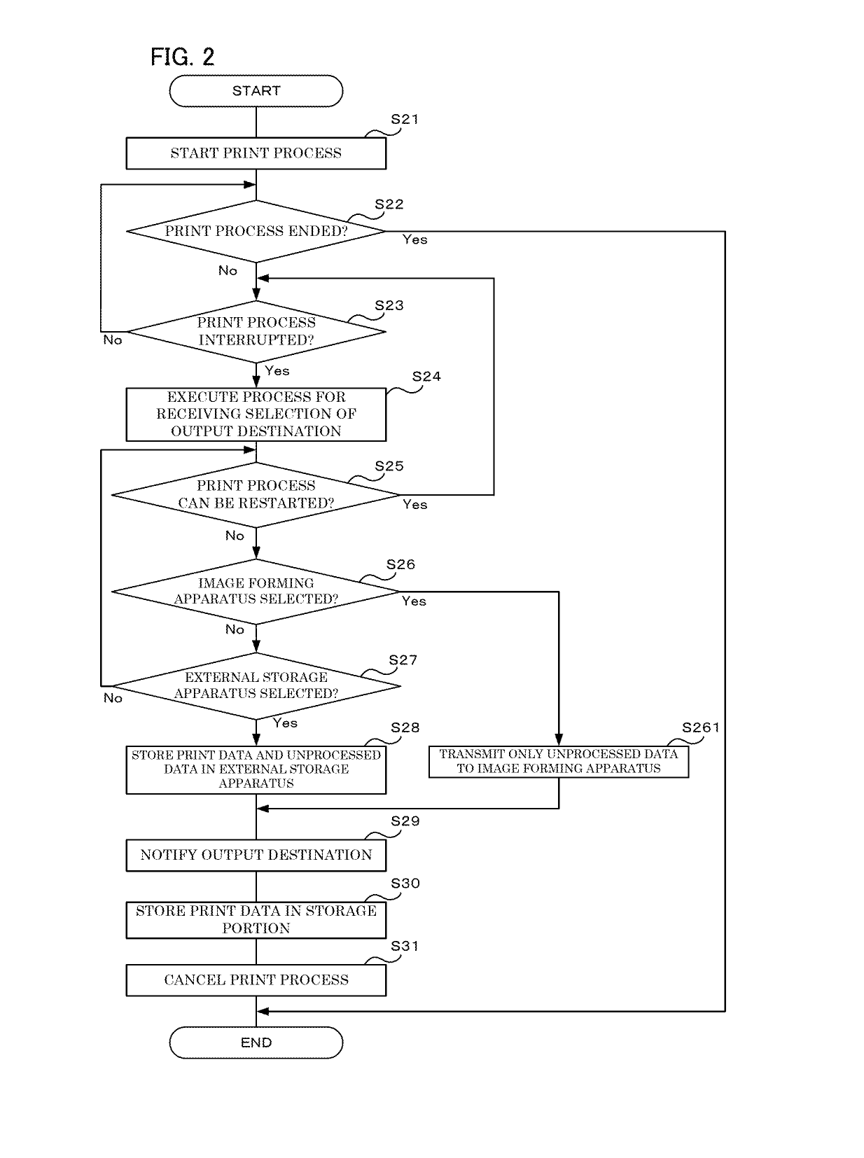

The following describes an example of the procedure of the print control process executed by the control portion 21 in the first image forming apparatus 20, with reference to FIG. 2. It is noted that the control portion 21 executes the print control process when it receives the print data from the information processing apparatus 10. In addition, when the first image forming apparatus 20 includes an image reading portion configured to read an image from a document sheet, the print control process is executed even in the case where a copy job is executed using the image reading portion. Furthermore, when the first image forming apparatus 20 includes a facsimile function for performing a facsimile communication via a communication line, the print control process is executed even when a facsimile receiving job is executed.

<Step S21>

In step S21, the control portion 21 starts a print process for the print data. Specifically, the control portion 21 converts the data format of the image data of each page included in the print data, from the PDL data to the bit map data, and executes the print process for each page. It is noted that step S21 is an example of the print step, and is executed by the print processing portion 211 of the control portion 21.

<Step S22>

In step S22, the control portion 21 determines whether or not the print process for the print data ended. Here, upon determining that the print process for the print data ended (Yes side in S22), the control portion 21 ends the print control process. On the other hand, upon determining that the print process for the print data has not ended (No side in S22), the control portion 21 moves the process to step bS23.

<Step S23>

In step S23, the control portion 21 determines whether or not the print process for the print data has been interrupted. For example, in the first image forming apparatus 20, when a failure such as a paper jam, an “out of toner”, or an “out of paper” occurs, the print process is interrupted. Here, upon determining that the print process has been interrupted (Yes side in S23), the control portion 21 moves the process to step S24. On the other hand, upon determining that the print process has not been interrupted (No side in S23), the control portion 21 returns the process to step S22.

<Step S24>

In step S24, the control portion 21 executes the selection receiving process for receiving selection of the output destination of the print data or the unprocessed data. It is noted that step S24 is an example of the selection step, and is executed by the selection processing portion 212 of the control portion 21.

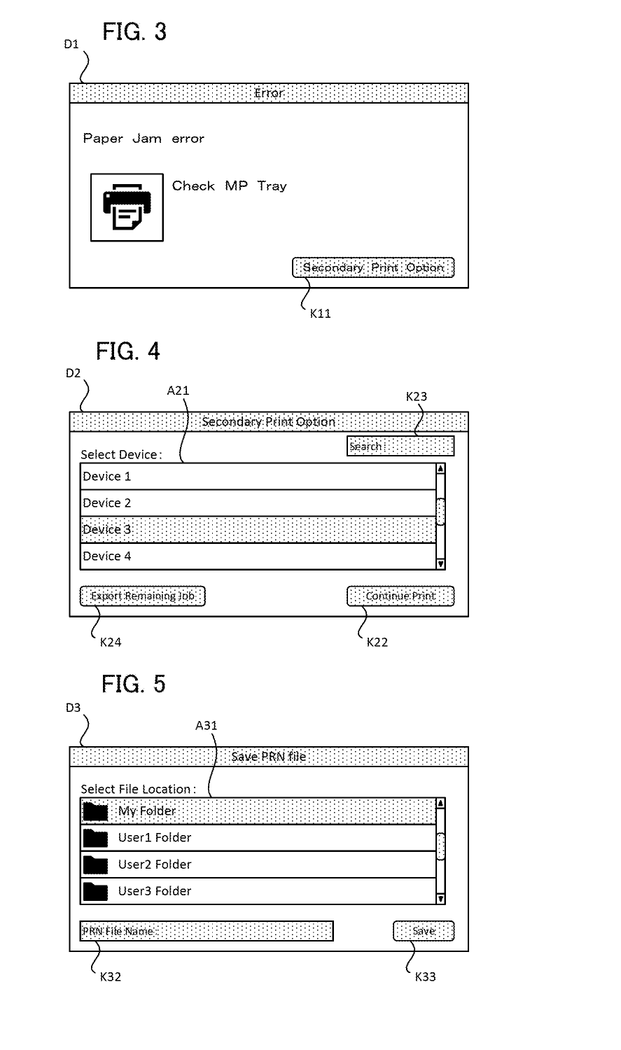

First, the control portion 21 causes the operation display portion 23 to display an error screen D1 on which, for example, the reason why the print process for the print data has been interrupted is displayed. Here, FIG. 3 is a diagram showing an example of the error screen D 1. In the error screen D1 shown in FIG. 3, it is indicated that the print process has been interrupted due to a paper jam. In addition, an operation key K11 is displayed on the error screen D1. The operation key K11 is operated to output the print data or the unprocessed data whose processing has been interrupted, to another image forming apparatus.

When the operation key K11 is operated, the control portion 21 causes the operation display portion 23 to display a selection screen D2 for selection of the output destination of the print data or the unprocessed data. Here, FIG. 4 shows an example of the selection screen D2. In the selection screen D2 shown in FIG. 4, an operation area A21 and operation keys K22-K24 are displayed, and operation signals of the operation area A21 and the operation keys K22-K24 are input to the control portion 21.

A list of second image forming apparatuses 30 with which the first image forming apparatus 20 can communicate at that time is displayed in the operation area A21 as selection candidates. The control portion 21 receives a selection operation of selecting a second image forming apparatus 30 from among those included in the list of the operation area A21. The operation key K22 is an operation portion that receives an operation for executing an output of the print data or the unprocessed data to the second image forming apparatus 30 selected in the operation area A21. The operation key K23 is an operation portion for narrowing down, through a search, the second image forming apparatuses 30 displayed in the operation area A21. The control portion 21 extracts the second image forming apparatuses 30 to be displayed in the operation area A21 based on a character string input to the operation key K23.

On the other hand, the operation key K24 is an operation portion that receives an operation for externally outputting the print data or the unprocessed data whose processing has been interrupted. When the operation key K24 is operated, the control portion 21 causes the operation display portion 23 to display a setting screen D3 on which a setting is made to externally output the print data or the unprocessed data. Here, FIG. 5 shows an example of the setting screen D3. In the setting screen D3 shown in FIG. 5, operation areas A31 and A32 and an operation key K33 are displayed, and operation signals of the operation areas A31 and A32 and the operation key K33 are input to the control portion 21.

In the operation area A31A, a list of names (for example, folder names) of storage areas in the external storage apparatus 50 attached to the first image forming apparatus 20 is displayed as selection candidates. The control portion 21 receives a selection operation of selecting a storage area from among those included in the list of the operation area A31. It is noted that when a plurality of external storage apparatuses 50 are connected, a list of the plurality of external storage apparatuses 50 is displayed as selection candidates, an external storage apparatus 50 is selected from among those, and a list of names of storage areas provided in the selected external storage apparatus 50 is displayed. A file name can be input to the operation area A32 when the print data or the unprocessed data is to be stored in the external storage apparatus 50. The operation key K33 is an operation portion that receives an operation for storing the print data or the unprocessed data in the storage area selected in the operation area A31.

<Step S25>

In step S25, the control portion 21 determines whether or not the print process for the print data that has been interrupted can be restarted. Specifically, if the failure that was the cause of the interruption of the print process is recovered, the control portion 21 determines that the print process can be restarted. Here, when the control portion 21 determines that the print process can be restarted (S25: Yes), the print process is restarted, and the process moves to step S22. On the other hand, when the control portion 21 determines that the print process cannot be restarted (S25: No), the process moves to step S26.

<Step S26>

In step S26, the control portion 21 determines whether or not a second image forming apparatus 30 was selected in the selection receiving process. Specifically, the control portion 21 determines that a second image forming apparatus 30 was selected if a specific second image forming apparatus 30 was selected in the selection receiving process, and an operation for executing an output of the print data or the unprocessed data was performed if the operation key K22 was operated). Here, when the control portion 21 determines that a second image forming apparatus 30 was selected (S26: Yes), the process moves to step S261, and when the control portion 21 determines that a second image forming apparatus 30 was not selected (S26: No), the process moves to step S27.

<Step S261>

In step S261, the control portion 21 executes a transmission process for transmitting only the unprocessed data among the print data, to the second image forming apparatus 30 selected in the selection receiving process. It is noted that step S261 is an example of the output step, and is executed by the output processing portion 213 of the control portion 21.

This allows the second image forming apparatus 30 to execute the print process based on the unprocessed data. As a result, the user can obtain the whole print material of the print data by obtaining print materials respectively from the first image forming apparatus 20 and the second image forming apparatus 30. This prevents generation of a wasteful print material.

Meanwhile, when the data format of the print data has been converted to the bit map format, the control portion 21 may transmit the unprocessed data to the second image forming apparatus 30 after converting it to the PDL format. This reduces the amount of the unprocessed data to be transmitted to the second image forming apparatus 30, and thereby reduces the communication time.

It is noted that in step S261, control portion 21 may transmit the whole print data instead of the unprocessed data. With this configuration, in the second image forming apparatus 30, the print process is executed with respect to the whole print data. This makes it possible for the user to obtain the whole print material of the print data which is printed only by the second image forming apparatus 30 with homogeneous image quality.

In addition, in step S261, the control portion 21 may select either the print data or the unprocessed data, as the data to be transmitted to the second image forming apparatus 30, in accordance with a user operation. Furthermore, the type of the data (print data or unprocessed data) to be transmitted to the second image forming apparatus 30 may be set in advance in accordance with a user operation during, for example, the initialization of the first image forming apparatus 20.

<Step S27>

In step S27, the control portion 21 determines whether or not an external storage apparatus 50 was selected in the selection receiving process. Specifically, the control portion 21 determines that an external storage apparatus 50 was selected if a specific external storage apparatus 50 was selected in the selection receiving process, and an operation for outputting the print data or the unprocessed data was performed (the operation key K33 was operated). Here, when the control portion 21 determines that an external storage apparatus 50 was selected (S27: Yes), the process moves to step S28, and when the control portion 21 determines that an external storage apparatus 50 was not selected (S27: No), the process returns to step S25.

<Step S28>

In step S28, the control portion 21 executes a storage process for storing the print data and the unprocessed data, as separate files, in the storage area of the external storage apparatus 50 selected in the selection receiving process. It is noted that step S28 is an example of the output step, and is executed by the output processing portion 213 of the control portion 21.

This makes it possible for the user to attach the external storage apparatus 50 to, for example, a third image forming apparatus 40 that cannot be communicated with the first image forming apparatus 20 so as to cause the third image forming apparatus 40 to execute a print process based on the print data or the unprocessed data. In particular, since the external storage apparatus 50 stores both the print data and the unprocessed data, the user can arbitrarily select the print data or the unprocessed data and cause the print process to be executed.

Meanwhile, when the data format of the print data has been converted to the bit map format, the control portion 21 may store the print data and the unprocessed data in the external storage apparatus 50 after converting them to the PDL format. This reduces the amount of the print data and the unprocessed data to be stored in the external storage apparatus 50.

It is noted that the files of the print data and the unprocessed data are assigned file names based on the file name set on the setting screen D3. For example, when a file name “20150825” is input on the setting screen D3, the file of the print data is assigned a file name “20150825-1”, and the file of the unprocessed data is assigned a file name “20150825-2”.

In addition, although the present embodiment describes a case where both the print data and the unprocessed data are stored in the external storage apparatus 50, either the print data or the unprocessed data may be stored in the external storage apparatus 50. For example, in step S28, the control portion 21 may receive a selection operation for selecting either the print data or the unprocessed data. Furthermore, the type of the data (print data or unprocessed data) to be stored in the external storage apparatus 50 may be set in advance during, for example, the initialization of the first image forming apparatus 20, in accordance with a user operation.

<Step S29>

Subsequently, when the print data or the unprocessed data is output in step S261 or step S28, in step S29 following those steps, the control portion 21 notifies the information processing apparatus 10 that is the transmission source of the print data, of the output destination of the print data or the unprocessed data. It is noted that step S29 is executed by the notification processing portion 215 of the control portion 21.

With the above-described configuration, the user of the information processing apparatus 10 can recognize the transmission destination of the print data or the unprocessed data. For example, even when the print data or the unprocessed data is transmitted to a second image forming apparatus 30 or stored in the external storage apparatus 50 by another user who is different from the user of the information processing apparatus 10, it is possible to let the user of the information processing apparatus 10 recognize the output destination of the print data or the unprocessed data.

<Step S30>

In step S30, the control portion 21 stores the print data in the storage portion 27. This enables the user to read the print data from the storage portion 27, and re-execute the print process for the print data in the first image forming apparatus 20. It is noted that step S30 is executed by the storage processing portion 214 of the control portion 21.

In addition, the control portion 21 stores a storage date/time in correspondence with each piece of print data stored in the storage portion 27, and deletes each piece of print data after a predetermined storage period has passed since the storage date/time corresponding to that piece of print data. This restricts the amount of print data stored in the storage portion 27.

<Step S31>

In step S31, the control portion 21 executes a cancel process for canceling the print job of the print data. It is noted that step S31 is executed by the cancel processing portion 216 of the control portion 21. With this execution, even when the failure that is the cause of the interruption of the print process is recovered, the remaining print process for the print data is not executed. Accordingly, this prevents a wasteful execution of a print process for the print data in the first image forming apparatus 20.

As described above, in the image forming system 1, even if a print process for print data in the first image forming apparatus 20 is interrupted, a print process for the print data or the unprocessed data can be executed by using a second image forming apparatus 30 or a third image forming apparatus 40. Also, in the first image forming apparatus 20, the user can select a second image forming apparatus 30 or an external storage apparatus 50 as the output destination of the print data or the unprocessed data. That is, the user can arbitrarily select a method for printing the print data whose printing has been interrupted.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a print processing portion configured to execute a print process based on print data;
a selection processing portion configured to, when the print process has been interrupted, select, as an output destination of the print data processed in the interrupted print process, either an image forming apparatus with which its associated image forming apparatus can communicate, or an external storage apparatus to which its associated image forming apparatus is connected, in accordance with a user operation; and
an output processing portion configured to execute an external output process for outputting at least one of the print data and unprocessed data to the output destination selected by the selection processing portion after the print process has been interrupted, the unprocessed data being part of the print data on which the print process has not been executed.

2. The image forming apparatus according to claim 1, wherein
in a case where the output destination is the external storage apparatus, the output processing portion outputs, as separate files, the print data and the unprocessed data to the output destination.

3. The image forming apparatus according to claim 1 further comprising:
a storage processing portion configured to, upon execution of the external output process by the output processing portion, store the print data in a storage portion provided in its associated image forming apparatus, and delete the print data from the storage portion after a predetermined storage period passes.

4. The image forming apparatus according to claim 1 further comprising:
a notification processing portion configured to, upon execution of the external output process by the output processing portion, notify the output destination.

5. The image forming apparatus according to claim 1 further comprising:
a cancel processing portion configured to, upon execution of the external output process by the output processing portion, cancel the print process of printing the print data in its associated image forming apparatus.

6. An image forming method executed by a processor installed in an image forming apparatus, the image forming method comprising:
a print step of executing a print process based on print data;
a selection step of, when the print process has been interrupted, selecting, as an output destination of the print data processed in the interrupted print process, either an image forming apparatus with which its associated image forming apparatus can communicate, or an external storage apparatus to which its associated image forming apparatus is connected, in accordance with a user operation; and
an output step of executing an external output process for outputting at least one of the print data and unprocessed data to the output destination selected in the selection step after the print process has been interrupted, the unprocessed data being part of the print data on which the print process has not been executed.
